(19) United States
(12) Patent Application Publication
(10) Pub. No.: US 2008/0314266 A1
(43) Pub. Date: Dec. 25, 2008

(54) Pad Printing Machine

(75) Inventor: Holger Reinholdt, Freudenstadt (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW MORLOCK GMBH, Dornstetten (DE)

(21) Appl. No.: 12/097,545

(22) PCT Filed: Dec. 11, 2006
(86) PCT No.: PCT/IB06/03554

§ 371 Date: Jun. 16, 2008

(30) Foreign Application Priority Data
Dec. 17, 2005 (DE) 10 2005 060 550.8

(51) Int. Cl. B41F 17/08

(52) U.S. Cl. 101/40

(57) ABSTRACT

In present invention relates to a pad printing machine having a printing subassembly support that bears several pad printing subassemblies, at least two object carriers are used and together with the printing subassemblies of the printing subassembly support, constitute one print station wherein multiple print-objects, which are configured on the object carriers, can be printed simultaneously.

### TECHNICAL FIELD

The disclosure relates to a pad printing machine.

### BACKGROUND

Illustratively pad printing machines are known from the U.S. Pat. Nos. documents 5,662,041; 6,393,981 B1 and from the European patent document EP 0 379 447 A1.

There is a need to increase the productivity of such machines.

### SUMMARY

In a pad printing machine, a printing-subassembly support is rotatable in a horizontal plane and has thereon a plurality of pad printing subassemblies that can be rotatably moved toward and away from print stations. At least two object carriers move print-objects at the print stations into a position wherein they can be printed by the printing subassemblies. Each print station defines a zone wherein a print-object held in place on an object carrier can be printed by a printing subassembly of the printing sub-assembly support. A motor drive rotates the printing subassembly support. A control unit powers the motor drive of the printing subassembly support and the printing subassemblies in a manner that print-objects can be printed simultaneously at all print stations.

### BRIEF DESCRIPTION OF THE DRAWINGS

Preferred and illustrative embodiment modes of the present invention are elucidated below and in relation to the appended drawings.

FIGS. 1, 2, and 3 are schematic sideviews of a known printing equipment in various operating stages,

FIG. 4 is a schematic topview of a pad printing machine of the invention,

FIG. 5 is a schematic topview of another embodiment mode of the pad printing machine of the invention, and

FIG. 6 is a schematic topview of still another embodiment mode of a pad printing machine of the invention.

### DETAILED DESCRIPTION

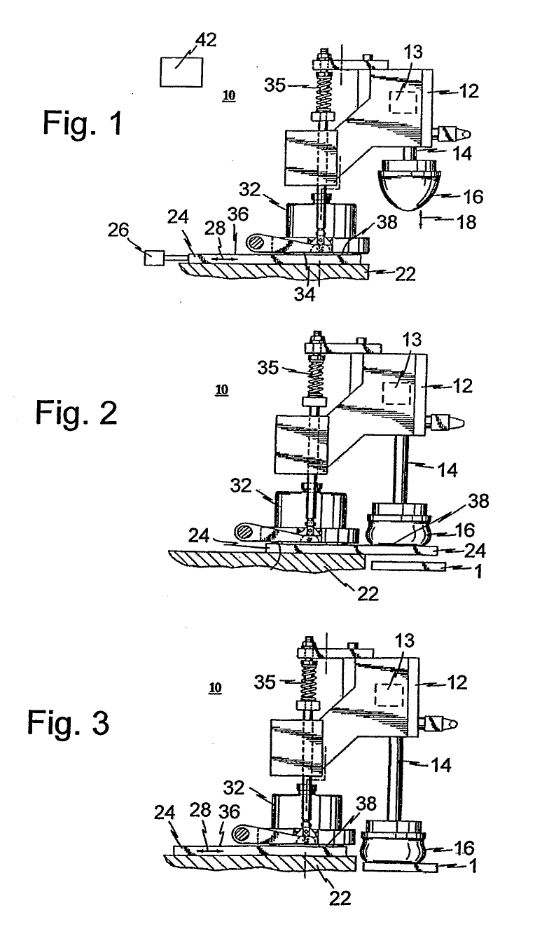

FIGS. 1, 2 and 3 show the essential components of a pad printing sub-assembly 10. The pad printing subassembly 10, hereafter only called printing subassembly, comprises an upper part 12 fitted with a drive 13 moving up and down a pad bar 14 guided within said upper part 12. A printing pad 16 (stamp element) is mounted to the lower side of the pad bar 14. Said up and down motion is schematically indicated by a double arrow 18 in FIG. 1. To generate the motions of the pad bar 14, the drive 13 is fitted with an omitted drive force generator, for instance a pneumatic or hydraulic drive element or an electric motor.

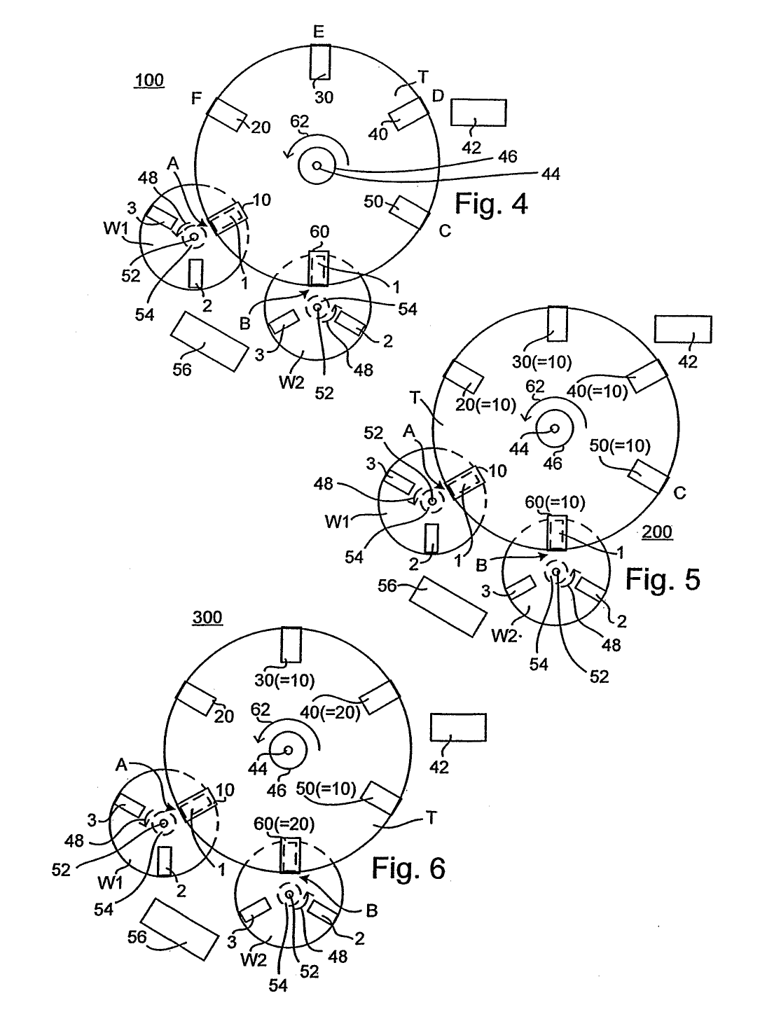

A cliché 24, or a carriage fitted with a cliché 24, is displaceably mounted to a lower part 22 of the printing subassembly 10 and is displaceable by means of a drive 26 in the direction of a double arrow 28 (FIG. 4) between an ink pickup position shown in FIG. 1 and an ink feed position shown in FIG. 2. Preferably the directions of displacement 28 of the cliché 24 shall be perpendicular to the up-and-down displacements 18 of the printing pad 16.

An ink cup 32 rests by its downward pointing beaker rim 34 designed as a doctor on the upward pointing surface 36 of the cliché 24. Preferably a compression element such as a compression spring 35 or a tension spring or a magnetic force is used to press the ink cup 32 against the cliche surface 36 to reliably assure that the cup rim 34 acting as a doctor shall prevent printing ink from leaking out of the ink cup.

FIG. 1 shows the printing subassembly 10 in its rest position. In this instance the printing pad 16 is in an upper rest position and the cliché 24 is situated in a rear ink pickup position. A print image 38 is formed by one or more recesses at the upward pointing surface 36 of the cliche 24. The print image 38 is situated underneath the ink cup 32 within its beaker rim 34, whereby ink is able to enter the recess(es) of the print image 38 while at the same time being prevented from leaking out of the ink cup 34 through the doctor's edge.

The recess(es) representing the print image at the surface of the cliché 24 may be formed by etching or other techniques,

FIG. 2 shows a print image application state which, starting from the state shown in FIG. 1, was attained in that first the cliché 24 was moved forward into the ink delivery position and then the printing pad 14 was moved together with the pad bar 14 by the drive 13 such a distance downward that the printing pad came to rest on the print image 38 of the cliché 24 and shall pick up ink from the recess(es) constituting the print image 38.

FIG. 3 shows the printing state of the printing subassembly. Starting from the printing state shown in FIG. 2, that of FIG. 3 was attained in that first the printing pad 16 was moved by the pad bar 14 from the cliché 24 upward either into the upper rest position shown in FIG. 1 or into an intermediate position below said rest position, and in that thereupon the cliché 24 was moved back into the ink pickup position of FIG. 3 and FIG. 1, thereupon the printing pad 16 being moved so far downward into a printing position that the underside of the printing pad 16 shall touch the top side of an print-object 1, whereby the printing ink is transferred from the printing pad 16 onto said object 1.

The object to be coated 1, hereafter print-object 1, may be mounted lower than the cliché 24, whereby said print-object 1 may be moved into its printing position underneath the printing pad 16 already in the operational state of FIG. 1 or in the operational state of FIG. 2. In other embodiment modes the print-object 1 may be positioned in its printing position at the same height as the cliché 24 or higher than it. As regards the embodiment modes of the invention of a pad printing machine discussed below in relation to FIGS. 4, 5 and 6, the print-object 1, 2 3 may be configured below, at the same height as, or higher than the cliché 24.

Another embodiment mode of the invention may comprise a horizontally displaceable ink cup 32 whereas the cliché 24 is mounted in fixed in place.

A control unit 42 drives mutually coordinated displacements of the pad bar 14 and the cliché 24 (or the ink cup 22 in lieu of the cliché 24) and preferably also drives the related feeding and evacuation of print-objects 1 etc. Preferably this control unit 42 is electronic, for instance being computerized. Said control unit 42 also drives coordinated displacement sequences of the pad printing machine of the invention that are elucidated below by illustrative embodiments shown in FIGS. 4, 5 and 6.

The pad printing machines 100, 200 and 300 of FIGS. 4, 5 and 6 each comprise one printing subassembly support T which bears a plurality of at least two or more printing subassemblies of the above described kind or of another and which moves the printing subassemblies in sequence on an endless revolving path toward a plurality of hold stations A, B, C, D, E, F, of which at least two hold stations, for instance A and B, are print stations where print-objects 1, 2, 3 can be printed. The other hold stations, for instance C, D, E, F may be unoccupied or also be print stations, or one or more of these other hold stations may be designed for cleaning the printing pad 16.

The printing subassembly support T may be a looping, planar conveyor unit, for instance a conveyor belt. Preferably and as shown in FIGS. 4, 5, and 6, the printing subassembly support T may be a body or rotation, for instance in the manner of a rotating disk such as a lazy susan, a turntable or a turnstile mounted in rotatable manner about a central, vertical center axis 44. A drive 46 drives the printing subassembly support T and is fitted with a drive force generator, preferably a pneumatic or hydraulic or an electrical device such as an electric motor. Preferably the drive force generator is a stepping drive. The printing subassembly support T is driven in rotation by the drive 46 preferably at a constant direction of rotation 62 about at least 360° or preferably at arbitrary multiple rotations each of 360°. In the process the printing subassembly support T is rotated by predetermined units of angles of rotation either from the hold station to the hold stations A-F or from set to set, each set of hold stations containing at least two of the hold stations A-F. In the preferred embodiment mode, the drive 46 is a stepping drive, for instance an electric stepping motor, of which the number of rotational steps required to rotate the printing subassembly each time about one unit of angle of rotation shall be adjustable.

At least two, preferably more than two printing subassemblies 10 are configured on the printing subassembly support T at specific circumferential angular positions distributed over 360° at specific circumferential, angular positions about its vertical axis of rotation 44 in such manner that they can print print-objects when at the print stations (for instance A and B). Preferably the circumferential angular positions are equidistant. The printing subassemblies 10 preferably all are at the same radial distance between the pad center and the axis of rotation 44 of the printing subassembly support.

Illustratively six printing subassemblies 10 are configured on the printing subassembly support T and are denoted in FIGS. 4, 5 and 6 by the reference numerals 10, 20, 30, 40, 50, and 60. These printing subassemblies 10 through 60 are arrayed circumferentially, angularly equidistant from each other about the vertical axis of rotation 44, the origin of said circle being the axis of rotation 44 of the printing subassembly support T.

The print stations are designed in a manner that in each case at least one object carrier W1 or W2 is configured at several or all, at least at two stopping stations A and B, each of said object carriers keeping at least one print-object 1 or 2 or 3 in its print position wherein it can be printed by one of the printing subassemblies 10 through 60. The hold stations and hence the print stations and also the minimum of two object carriers W1, W2, where they keep a print-object 1, 2 or 3 in a print position, are configured about the axis of rotation 44 of the printing subassembly T adjacently to latter and at the same equidistant, circumferential angles as the printing subassemblies.

At least one print-object 1, 2, or 3 may be present on each of the object carriers W1 and W2 and be kept in a position wherein it may be printed by one of the printing subassemblies 10 through 60. Preferably several print-objects 1, 2, 3 etc. shall be simultaneously present on each object carrier W1 and W2 and can be sequentially moved by said object carriers into the print station and then out of it. The displacements of the object carriers W1 and W2 may be linear or, preferably, as shown in FIGS. 4, 5 and 6, they may be rotational as indicated by an arrow 48 in the direction shown or in the opposite one. Preferably the object carriers W1 and W2 are rotational, for instance being turntables or turnstiles. These rotational object carriers W1 and W2 rotate about a vertical axis of rotation 52 and are coordinated by a drive 54—which is fitted with an electric, hydraulic or pneumatic drive power generator—with the rotations of the printing subassembly support T in rotational and preferably stepped rotational manner.

Loading and unloading the object carriers W1 and W2 may be manual or preferably automated by means of a feeding and evacuation device, illustratively at a loading and unloading station 56.

All pad printing machines 100, 200 and 300 of the invention comprise the printing subassembly support T bearing at least two or preferably a larger number of printing subassemblies 10, 20, 30 etc., and at least two object carriers W1 and W2 each used to position at least one print-object 1, 2, 3 etc. into a position wherein in may be printed by one of the printing subassemblies each time at one of the hold stations that serve as print stations, for instance at print stations A and B. The control unit 42 drives all motions and functions of the pad printing machine.

Preferably the number of the printing subassemblies 10, 20, 30 etc. of the pad printing machine of the invention is a selected in a manner that dividing said number by an integer in turn results in an integer and that the number of the print stations, for instance print station A, B (or A, B, C or A, B, C, D etc.) always shall be equal to an integer resulting from the division.

Illustratively the pad printing machine 100 of FIG. 4 comprises six printing subassemblies 10, 20, 30, 40, 50, 60 designed to print different colors so that jointly, after a full rotation of 360° of the printing subassembly 10, a print picture 38 is printed containing six colors (six-color print). Accordingly the ink cups 32 of the printing subassemblies contain different colors. Obviously also other multicolor prints may be made, for instance two-color, three-color prints etc.

The printing subassembly support T of the pad printing machine of FIG. 4 is driven stepwise by the drive 46 from stop station to stop station A, B, C etc. each time by one angular unit corresponding to the circumferential angular distance between two adjacent printing subassemblies 10, 20, 30 etc.

As regards the pad printing machine 200 of FIG. 5, its components are the same as in FIG. 4 and are denoted by the same reference symbols, the difference being that the print images 38 of the cliché 24 and/or the printing inks in the ink cups 32 are identical in all printing subassemblies 10, 20, 30, 40, 50, and 60. Accordingly a bracketed term “(=10)” has been added in FIG. 5 to the reference numerals 20 through 60 of the printing subassemblies. After each double-printing procedure, the printing subassembly support T shall be rotated by two angular units, in other words by the two hold stations, or still in other words, by two printing subassemblies. As a result print-objects 1 and 1, or 2 and 2, or 3 and 3 etc. present on the two object carriers W1 and W2 each will be simultaneously printed by the two printing subassemblies 20 and 30, then by the two printing subassemblies 40 and 50, and then again by the two printing subassemblies 10 and 60. Contrary to the design having a single print station, the above feature of the invention allows doubling production. By configuring three object carriers W1, W2 (W3) in a manner that a printing subassembly shall be in its printing position at each of them, productivity shall be tripled as the printing subassembly support T is correspondingly rotated farther each time by three printing subassemblies (three angular units; three hold stations) each time by three print stations A, B, (C). Broadly speaking, the printing subassembly support T shall be rotated farther after each printing procedure by so many hold stations as there are hold stations designed as print stations.

The maximum number of print stations in the embodiment of FIG. 5 is the number of printing subassemblies.

The pad printing machine 300 of FIG. 6 illustratively comprises again a printing subassembly support T on which are mounted again illustratively six printing subassemblies 10, 20, 30, 40, 50 and two objects supports W1 and W2. Together with the printing subassemblies 10, 20, 30 etc. of the printing subassembly support T, the object carriers W1 and W2 constitute a number of print stations A and B equal to the number of object carriers W1 and W2 as already described above in relation to FIGS. 4. and 5. There being six printing subassemblies 10 through 60, again a maximum of six hold stations is possible, at least two hold stations constituting the print stations A and B.

The pad printing machine 300 of FIG. 6 differs from the other pad printing machines 100 and 200 in that two circumferentially adjacent printing subassemblies of the printing subassembly support T are fitted with a different print image on their clichés 24 and/or another ink in their ink cups 32. The printing subassembly support T of FIG. 6, as in the case relating to FIG. 5, is also automatically rotated farther following each printing procedure simultaneously occurring at all print stations A, B by twice the circumferential angular spacing of two adjacent object carriers W1 and W2. In other words: the printing subassembly support T each time is rotated farther by two units of angular rotation.

Illustratively as regards the embodiment of FIG. 6, the printing at the two print stations A and B of the print-objects on the object carriers W1 and W2 is carried out simultaneously by the printing subassemblies 10 and 60. Following printing, the printing subassembly support T is rotated farther by twice the angular spacing of two printing subassemblies, whereby the printing subassembly 20 moves into the print station B and the printing subassembly 30 into the print station A in order to print print-objects 2 on the object carriers W1 and W2. When next the print subassembly support T is rotated farther by twice an angular spacing between two printing subassemblies, the printing subassembly 40 moves into the print station B and the printing subassembly 50 moves into the print station A, etc.

The embodiment of FIG. 6 allows printing print images on two print-objects 1 or two print-objects 2 or two print-objects 3 etc. which constitute supplementary information or additional image subjects concerning the print image and/or the print color. For instance the print-objects 1, 2, 3 on an object carrier W1 in the print station A may be half a housing of some device, whereas the print-objects 1, 2, 3 on the other object carrier W2 in the other print station B are another housing half, these two housing halves together forming one full housing. In another illustrative embodiment mode the print-object 1 on the object carrier W1 may be the cover and the print-object 1 on the other object carrier W2 may be the base of a device. Illustratively a company name may be printed on the cover and technical device information may be printed on the base. Moreover it is possible to print the same print images in different colors/inks on the two associated device parts or print-objects 1 and 1 (or 2 and 2 etc.). Manifestly a plurality of further combinations of image patterns and/or printing inks/colors is available.

To elucidate such versatile printing in FIG. 6, the printing subassemblies again are denoted by the reference numerals 10, 20, 30, 40, 50 and 60, though the printing subassemblies 30, 40, 50 and 60 are additionally denoted, by brackets and equal signs, by the notation of the printing subassembly 10 or 20 which prints the same print image; 30 (=10); 40 (=20); 50 (=10); and 60 (=20).

The circumferential angular spacing between the printing subassemblies 10 through 60 depends on the number of printing subassemblies and in the case of six printing subassemblies is 60° for each (360°/6). For a larger or smaller number of printing subassemblies these circumferential angular spacings shall be respectively smaller and larger. As regards the pad printing machine of FIG. 4, the angular unit of rotation of the printing subassembly support T after each printing procedure is 60°. As regards the pad printing machines 200 and 300 of FIGS. 5 and 6, the printing subassembly support T is rotated farther, following each printing procedure, by two angular units of rotation which are a total of 120°. Consequently, following each printing procedure, the angle of rotation of the printing subassembly support T depends on the circumferential angular spacing between the printing subassemblies 10 through 60 and moreover either on using a multicolor print according to FIG. 4 or whether simultaneously several identical print images according to FIG. 5 shall be printed, or whether two or three or more parts belonging to a single product shall be printed with different print images and/or with different printing inks in the manner discussed in relation to FIG. 6.

The printing subassembly support T and the object carriers W1 and W2 may be fitted with their own drives or all may be driven by a single drive. Moreover a single drive may be used to drive both object carriers W1 and W2 and to use another drive to drive the printing subassembly T.

### Guidelines for Possible Embodiment Modes of the Present Invention:

The printing subassemblies 10 through 60 preferably shall be configured at equal circumferential angular spacings between them, preferably along a circle of which the center is the axis of rotation 44. However other embodiment modes also are feasible. Illustratively the printing subassemblies 10 through 60 may be configured at different radii from the axis of rotation 44 or at different circumferential angular spacings from each other. The positions of the printing sub-assemblies 10 through 60. are matched to the positions of the object carriers W1, W2 and, as called for, also to the positions of one or more work stations, for instance a cleaning station to clean the printing pad 16 in a manner that the required operations may be carried out, in particular printing the print-objects 1, 2, 3, 4, 5 etc. on the object carriers W1, W2, W3, W4 etc. The further print-objects 4, 5 etc. are not shown, and the further object carriers W3, W4 etc. are not shown either, instead such notation shall make it clear that the number of object carriers and the number of the print-objects borne on the object carriers is not restricted to a particular number. The maximum number possible of object carriers W1, W2 corresponds to the maximum number of printing subassemblies 10 through 60 that are present. Again the number of printing subassemblies is not restricted to a specified number, instead all embodiment modes should comprise at least two printing subassemblies and at least two workpiece supports. These rotations of the printing subassembly support T are controlled in a manner that whenever being positioned opposite a print-object on an object carrier, the printing subassemblies shall be able to print the print-object. The printing subassembly support T preferably is rotated stepwise, though other embodiment modes allow rotating it continuously.

1. A pad printing machine, comprising:
a printing-subassembly support which is rotatable in a horizontal plane and on which are configured a plurality of pad printing subassemblies that can be rotatably moved toward and away from print stations;
at least two object carriers for moving print-objects at the print stations into a position wherein the print-objects can be printed by the printing subassemblies, each of the print stations defining a zone wherein a print-object held in place on an object carrier can be printed by a printing subassembly of the printing sub-assembly support;
a motor drive for rotating the printing subassembly support;
a control unit for powering the motor drive in such a manner that the print-objects can be printed simultaneously at all print stations.

2. Pad printing machine as claimed in claim 1, wherein the number of printing subassemblies is selected in a manner that when it is divided by an integer the resulting quotient also is an integer and that the number of the print stations is equal to the integer resulting from the division or a multiple thereof.

3. Pad printing machine as claimed in claim 1, wherein more printing subassemblies are configured on the printing subassembly support than there are print stations, and each time at least two of the printing subassemblies are situated at the print stations whereas the other printing subassemblies are situated in non-printing hold stations.

4. Pad printing machine as claimed in claim 1, wherein the printing subassembly support is a rotational body having a central, vertical axis of rotation, the printing subassemblies are distributed at a specific circumferential angular spacing from each other, said angular spacing being such that always two adjacent printing subassemblies may be positioned simultaneously at print stations near the object carriers in order to simultaneously print print-objects borne on these object carriers.

5. Pad printing machine as claimed in claim 1, wherein each object carrier is configured to be displaceable and to simultaneously hold several print-objects in order that said object carrier sequentially moves the print-objects it bears from an object receiving-position into the print position and then away from the print position.

6. Pad printing machine as claimed in claim 1, wherein said machine is configured to carry out multi-color printing, where the printing subassemblies for printing different colors are consecutively arrayed in the direction of displacement of the printing subassembly support.

7. Pad printing machine as claimed in claim 1, wherein all printing subassemblies are identically configured to print the same print image and that the control is configured to rotate the printing subassembly support each time by an angle of rotation corresponding to the summed circumferential angular spacings of all object carriers at the print stations wherein the print-objects may be printed simultaneously.

8. Pad printing machine as claimed in claim 1, wherein at least one of the printing subassemblies is configured to print a different print image than at least one of the other printing subassemblies and the control unit is configured in a manner that the printing subassembly support following each printing procedure is rotated farther by an angle of rotation corresponding to twice the circumferential angular spacing between two consecutive printing subassemblies and that, following every such further rotation of the printing subassembly support, printing procedures are carried out at all print stations in a manner that all different print images are printed simultaneously.

9. Pad printing machine as claimed in claim 1, wherein the printing subassembly support can be rotated in the same direction of rotation beyond 360°.
